(19) United States
(12) Patent Application Publication
(10) Pub. No.: US 2004/0192193 A1
(43) Pub. Date: Sep. 30, 2004

(54) Mobile signal relay for cellular transmission in remote areas

(76) Inventor: Kelan C. Silvester, Portland, OR (US)

Correspondence Address: Timothy N. Trop, TROP,PRUNER & HU P.C., STE 100, 8554 KATY FWY, HOUSTON, TX, 77024-1805, US

(21) Appl. No.: 09/974,587

(22) Filed: Oct. 9, 2001

(51) Int. Cl. H04B 7/15

(52) U.S. Cl. 455/11.1; 455/421; 455/422.1

(57) ABSTRACT

A large number of vehicles may be equipped with cellular repeaters. These repeaters may receive signals from proximate towers or proximate vehicles and forward them on in order to complete communications that would not otherwise be possible. Thus, vehicles that are attempting to make or receive cellular transmissions may have those transmissions completed via a mobile repeater in other vehicles. As a result, the range of existing cellular telephone systems may be extended without the need for an increased number of cellular towers.

### BACKGROUND

This invention relates generally to cellular communication systems and, particularly, to the use of cellular repeaters.

In a number of circumstances, cellular telephone users are frustrated by the lack of cellular telephone service. For example, when traveling along highways, the user may experience dropped calls because the user moves out of range of a sufficiently proximate cellular tower. In addition, in so-called pocket areas, users may experience the absence of cellular service because buildings or other geographical obstacles, such as mountains or valleys, mask communications with proximate towers.

Of course, one obvious solution is to increase the number of cellular towers. However, this approach comes with a number of disadvantages. The cellular towers and their maintenance may be expensive. In addition, many communities object to the presence of what are considered to be unsightly cellular towers.

Thus, it would be desirable to extend cellular service without increasing the number of cellular towers.

### BRIEF DESCRIPTION OF THE DRAWINGS

FIG. 1 is a schematic depiction of one embodiment of the present invention; and

FIG. 2 is a block diagram in accordance with one embodiment of the present invention.

### DETAILED DESCRIPTION

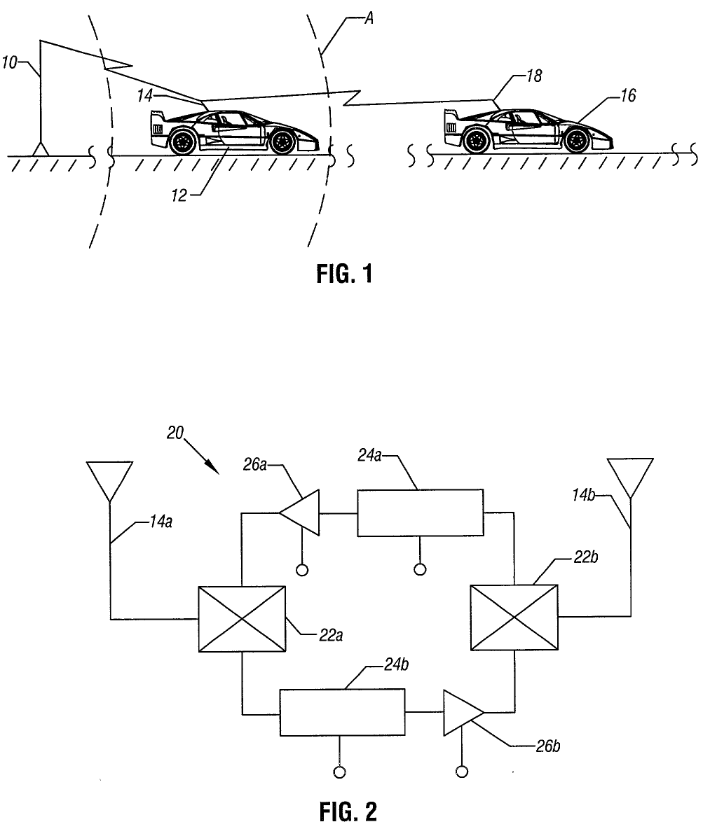

Referring to FIG. 1, a cellular user traveling in an automobile 16 may attempt to place a cellular phone call. However, in the illustrated example, the vehicle 16 is too far from the most proximate cellular tower 10 to establish communications. However, an intermediate vehicle 12, including a cellular repeater coupled to an antenna 14, is available. Thus, the outgoing transmission from the vehicle 16 may be received by the vehicle 12 and automatically retransmitted to the tower 10. Because the vehicle 12 is in range of the tower 10, the cellular call may be completed. The operator of the vehicle 12 may have no idea that his vehicle and its repeater is being used to forward a telephone call and may have no knowledge or access to the communication between the vehicle 16 and the tower 10.

If a large number of vehicles traveling on roads and highways are equipped with cellular repeaters, the range of existing cellular telephone systems may be extended. This may be accomplished without the need to increase the number of cellular towers. In effect then, each such vehicle becomes a mobile repeater. Whenever a repeater equipped vehicle happens to be in range of another vehicle that is not in range of any cellular tower, the repeater equipped vehicle acts to automatically forward incoming or outgoing communications. If the population of such repeaters is sufficient, the range of existing cellular phone systems may be greatly extended. Embodiments of the present invention may be applied in cellular telephone systems including those using Advanced Mobile Phone Service (AMPS), Code Division Multiple Access (CDMA), Time Division Multiple Access (TDMA), and Global System for Mobile Communications (GSM), as examples.

Cellular repeaters with relatively reasonable range may be made in sufficiently small form factors to be accommodated within passenger vehicles. Larger repeaters may be provided on large trucks that may extend the cellular system's range to an even greater degree. In some embodiments, the cellular repeaters may use existing radio technology in vehicles, such as existing AM/FM radios. In other words, the repeater may be incorporated with the existing automotive radio and may share components of such a radio.

Advantageously, the repeater does no signal processing so there is no way for cellular transmissions to be distorted, modified, recorded, intercepted, or the like. Thus, the repeater is advantageously simply a signal repeater.

Referring to FIG. 2, a cellular repeater may include a pair of antennas 14a and 14b. Advantageously, the antennas 14a and 14b may be well isolated from one another. The antenna 14a may receive signals that are passed through the duplexer 22a, the isolator 24b, and an amplifier 26b, and then passed out through the duplexer 22b and through the antenna 14b. Similarly, incoming signals received by the antenna 14 may be passed through the isolator 24a and amplifier 26a before proceeding outwardly through the antenna 14a via the duplexer 22a. The isolators 24a and 24b may provide filtering in some embodiments. The isolators 22 and the amplifiers 26 may be coupled, as indicated, to the vehicle's existing battery power supply.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
providing cellular repeaters in a plurality of vehicles; and
enabling those repeaters to receive cellular transmissions and to forward those transmissions between mobile users and proximate cellular towers.

2. The method of claim 1 including incorporating a cellular repeater into a vehicle radio.

3. The method of claim 1 including preventing the operator of a vehicle including a cellular repeater from intercepting a transmission to be forwarded.

4. The method of claim 1 including powering the repeater from a vehicle power supply.

5. The method of claim 1 including bi-directionally transmitting transmissions to and from cellular towers through said repeaters.

6. The method of claim 1 including bi-directionally transmitting transmissions to and from other mobile repeaters.

7. A cellular repeater comprising:
an antenna to receive or transmit a cellular signal;
an amplifier to amplify the cellular signal; and
a connection to a vehicular power supply.

8. The repeater of claim 7 including a pair of antennas.

9. The repeater of claim 7 including a pair of antennas, each of said antennas connected to a duplexer.

10. The repeater of claim 9 including a pair of amplifiers, each coupled to amplify a signal for one of said antennas.

11. The repeater of claim 7 including a pair of isolators, each isolator associated with one of said amplifiers.

12. A method comprising:
installing a repeater in a plurality of vehicles;
coupling the repeater to an automotive electrical system; and
enabling the repeaters to receive and transmit cellular communications and to forward those communications to proximate cellular towers.

13. The method of claim 12 including incorporating a cellular repeater into a vehicle radio.

14. The method of claim 12 including preventing the operator of a vehicle including a cellular repeater from intercepting a transmission to be forwarded.

15. The method of claim 12 including powering the repeater from a vehicle power supply.

16. The method of claim 12 including bi-directionally transmitting transmissions to and from cellular towers through said repeaters.
